(19) United States
(12) Patent Application Publication
(10) Pub. No.: US 2004/0246355 A1
(43) Pub. Date: Dec. 9, 2004

(54) Storage capacitor array for a solid state radiation imager

(76) Inventors: Ji Ung Lee, Niskayuna, NY (US); George Edward Possin, Niskayuna, NY (US); Douglas Albagli, Clifton Park, NY (US); William Andrew Hennessy, Schenectady, NY (US)

Correspondence Address: GENERAL ELECTRIC COMPANY, GLOBAL RESEARCH, PATENT DOCKET RM. BLDG. K1-4A59, NISKAYUNA, NY, 12309, US

(21) Appl. No.: 10/457,322

(22) Filed: Jun. 6, 2003

(51) Int. Cl. H04N 5/335

(52) U.S. Cl. 348/308

(57) ABSTRACT

Storage capacitor array for a solid state radiation imager. The imager includes several pixels disposed on a substrate in an imaging array pattern. Each pixel includes a photosensor coupled to a thin film switching transistor. Several scan lines are disposed at a first level with respect to the substrate along a first axis and several data lines are disposed at a second level along a second axis of the imaging array. Capacitors are disposed on the substrate, wherein each capacitor has a first electrode coupled to a corresponding photosensor and a corresponding thin film transistor and a second electrode coupled to a capacitor linear electrode.

### BACKGROUND OF THE INVENTION

The invention relates generally to imaging devices, and more specifically to a storage capacitor array for solid state radiation imagers.

Solid state radiation imagers typically comprise a large flat panel imaging device comprising a plurality of pixels arranged in rows and columns. Each pixel typically has a photosensor such as a photodiode coupled via a switching transistor (e.g., a thin film field effect transistor) to two separate address lines, a scan line and a data line. In each row of pixels, each respective switching transistor is coupled to a common scan line through that transistor's gate electrode. In each column of pixels, the readout electrode of the transistor (e.g., the source electrode of the transistor) is coupled to a data line. During nominal operation, radiation (such as an x-ray flux) is pulsed on and the x-rays passing through the subject being examined are incident on the imaging array. The radiation is incident on a scintillator material and the pixel photosensors measure (by way of change in the charge across the diode) the amount of light generated by x-ray interaction with the scintillator. Alternatively, the x-rays can directly generate electron-hole pairs in the photosensor (commonly called “direct detection”). The photosensor charge data are read out by sequentially enabling rows of pixels (by applying a signal to the scan line causing the switching transistors coupled to that scan line to become conductive), and reading the signal from the respective pixels thus enabled via respective data lines (the photodiode charge signal being coupled to the data line through the conductive switching transistor and associated readout electrode coupled to a data line). In this way a given pixel can be addressed through a combination of enabling a scan line coupled to the pixel and reading out at the data line coupled to the pixel.

One problem with such solid state radiation imagers is the limited dynamic range. The maximum signal level that can be handled is proportional to the bias voltage across the photodiode (typically 1-10V) and the capacitance of the photodiode (typically 0.4-0.8 pF for a 100 micrometer pitch, scales with the square of the pitch). Increasing the bias or the capacitance to increase the dynamic range has various drawbacks, including higher leakage currents or more point defects. Typically, in x-ray applications, the maximum x-ray signal level can be increased by decreasing the amount of light incident on the photodiode per x-ray. A resulting effect of such a solution is the corresponding increase in the sensitivity to electronic noise and thus the negatively effect on the minimum signal level.

It would therefore be desirable to provide a solid state radiation imager to enable a greater dynamic range and enhance the picture quality of the image

### BRIEF SUMMARY OF THE INVENTION

Briefly, in accordance with one embodiment of the invention, a storage capacitor array for an imager is provided. The imager comprises a plurality of pixels disposed on a substrate in an imaging array pattern comprising rows and columns. Each pixel comprises a respective photosensor coupled to a respective thin film switching transistor. A plurality of scan lines is disposed at a first level with respect to the substrate along a first axis of the imaging array pattern. Each row of pixels in the imaging array pattern has a respective scan line. Each of the respective scan lines is coupled to a respective gate electrode in the thin film switching transistor, for each pixel disposed along the respective row of pixels in the imaging array pattern. A plurality of data lines is disposed at a second level with respect to the substrate along a second axis of the imaging array pattern. Each column of pixels in the imaging array pattern has a corresponding data line. Each of the respective data lines is coupled to a respective readout electrode in the thin film switching transistors for each pixel disposed along the respective column of pixels in the imaging array. A storage capacitor array comprising a plurality of capacitors is disposed on the substrate. Each of the plurality of capacitors comprises a first electrode, a second electrode and a dielectric disposed between the first electrode and the second electrode. The first electrode is coupled to a corresponding photosensor and a corresponding thin film transistor, and the second electrode is coupled to a capacitor linear electrode.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1A is a plan view of a portion of an imager in accordance with the prior art;

FIG. 1B is a partial cross-sectional view of a representative pixel taken along line I-I of FIG. 1A;

FIG. 2 is a circuit diagram of an imaging array pattern of the imager shown in FIGS. 1A-1B; and

FIG. 3 is a circuit diagram of an imager with a storage capacitor array in accordance with one embodiment of this invention.

### DETAILED DESCRIPTION OF THE INVENTION

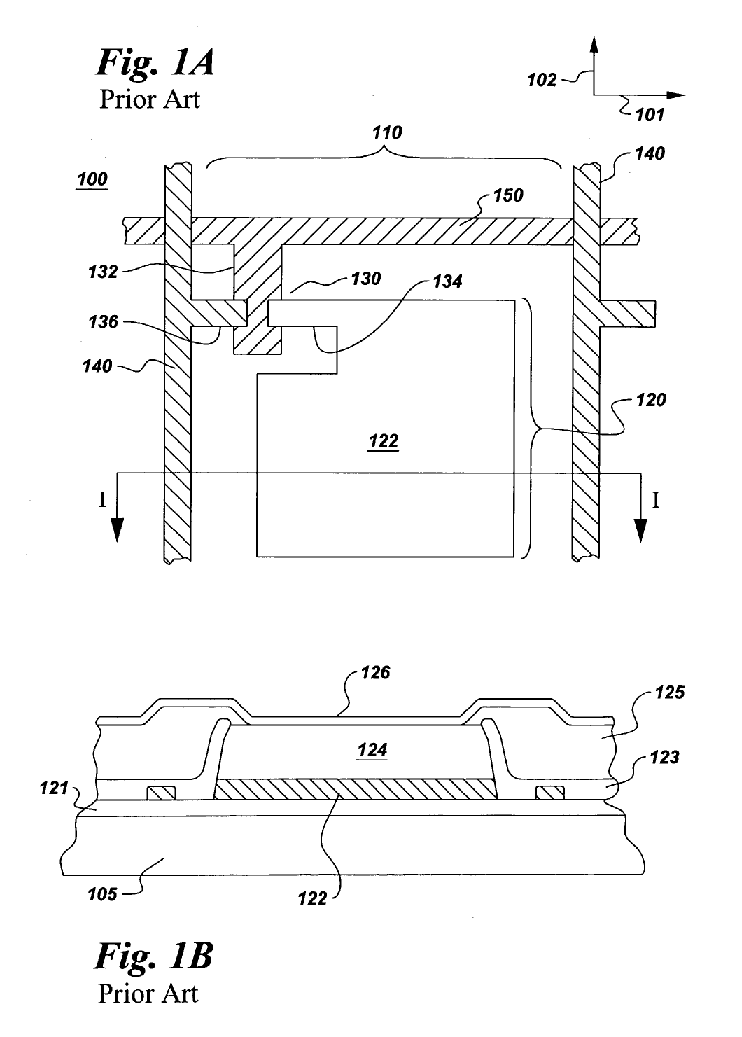

A solid state radiation imager 100 comprises a plurality of pixels 110 (a representative one of which is illustrated in FIG. 1A) that are arranged in a matrix-like imaging array pattern comprising rows and columns of pixels 110. For purposes of illustration and not limitation, imager 100 has a first axis 101 that is the axis along which the rows of pixels are aligned, and a second axis 102 that is the axis along which the columns of pixels are aligned. Each pixel 110 comprises a photosensor 120 and a thin film switching transistor 130. Photosensor 120 typically comprises a photodiode composed in part of a lower pixel electrode 122 that substantially corresponds with the active (that is, photosensitive) area of the device. Switching transistor 130 typically comprises a thin film field effect transistor (FET) having a gate electrode 132, a drain electrode 134 and a source electrode (or readout electrode) 136. Imager 100 further comprises a plurality of data lines 140 and scan lines 150 (collectively referred to as address lines). At least one scan line 150 is disposed along first axis 101 for each row of pixels in the imaging array pattern. Each scan line is coupled to the respective gate electrodes 132 of pixels in that row of pixels. At least one data line 140 is disposed along second axis 102 for each column of pixels in the imaging array pattern, and is coupled to the respective readout electrodes 136 of pixels in that column of pixels.

A partial cross-sectional view of one pixel 110 is presented in FIG. 1B. Photodiode 120 is disposed over a substrate 105. A first dielectric material layer 121 is typically disposed between pixel electrode 122 and substrate 105. Photodiode 120 further comprises a photosensitive material body 124 (typically comprising amorphous silicon) that is electrically coupled to a common electrode 126 that is disposed over the imaging array. Common electrode 126 comprises an optically transmissive and electrically conductive material, such as indium tin oxide or the like. A second dielectric material layer 123, typically comprising silicon nitride or the like, extends over a portion of the sidewalls of the photosensitive material body 124, and a third dielectric layer 125, comprising polyimide or the like, is disposed between common electrode 126 and other components in the imaging array (except for the contact point to photosensitive material body 124 through a via in second dielectric material layer 123 and third dielectric layer 125).

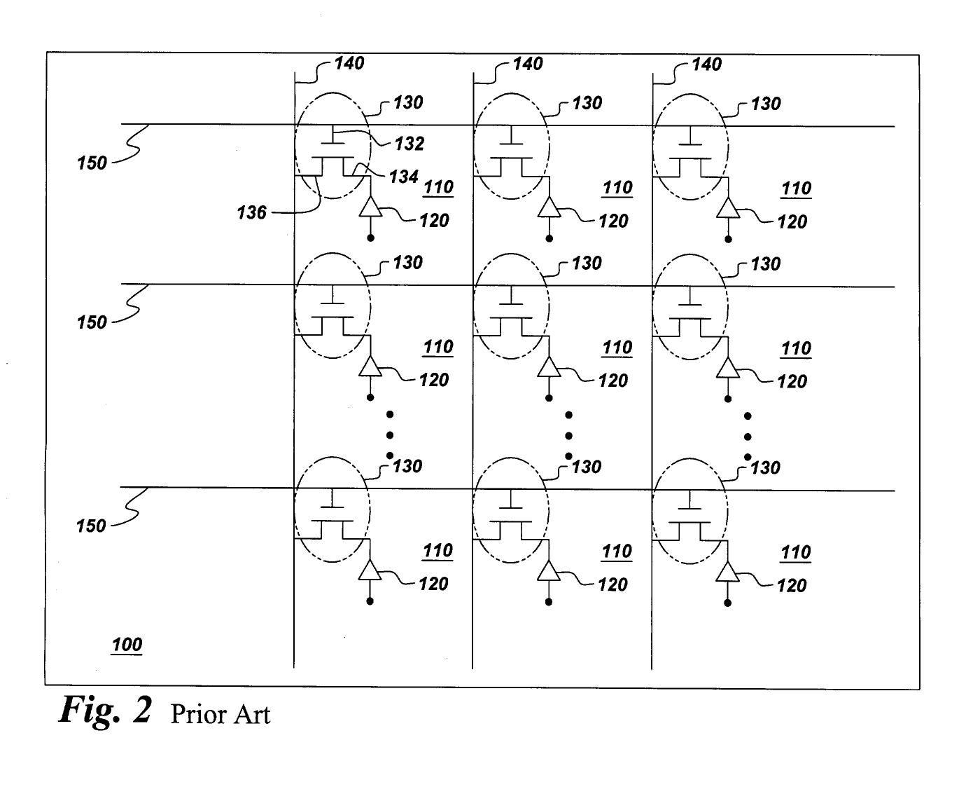

FIG. 2 is a circuit diagram of the imager 100 shown in FIGS. 1A-1B. FIG. 2 shows the plurality of pixels 110, wherein each pixel comprises a photosensor 120 such as a photodiode and a thin film switching transistor 130 such as a FET having a gate electrode 132, a drain electrode 134 and a source electrode (or readout electrode) 136. The imaging array pattern in FIG. 2 also shows the plurality of data lines 140 and scan lines 150.

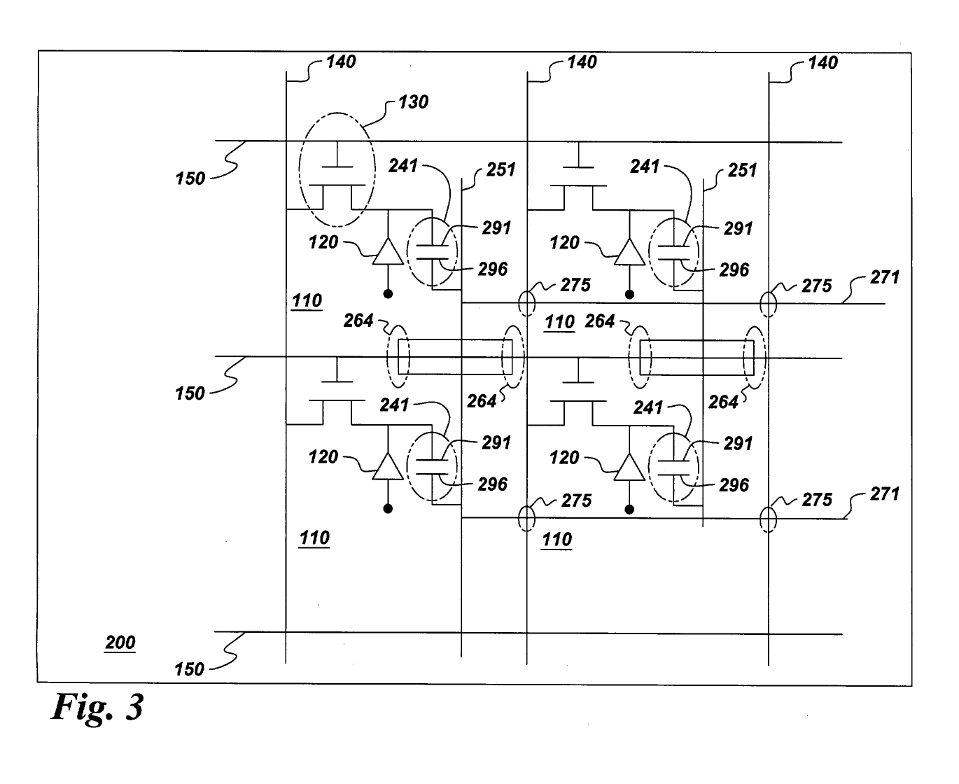

FIG. 3 is a circuit diagram of an imager 200 in accordance with one embodiment of this invention. The imager 200 is similar to the imager 100 shown in FIGS. 1A-1B and FIG. 2, except that this imager comprises a storage capacitor array. The imager 200 comprises a plurality of pixels 110 disposed on a substrate in an imaging array pattern comprising rows and columns. In one embodiment, the substrate is glass with a coefficient of thermal expansion similar to silicon. Each pixel comprises a respective photosensor 120 coupled to a respective thin film switching transistor 130.

The imager 200 further comprises a plurality of scan lines 150 and a plurality of data lines 140. The data lines and scan lines are electrically isolated by a deposited thin-film dielectric layer or layers.

Imager 200 further comprises the storage capacitor array. The storage capacitor array comprises a plurality of capacitors 241 disposed on the substrate. Each capacitor 241 comprises a first electrode 291, a second electrode 296 and a dielectric disposed between the first electrode and the second electrode, respectively.

The dielectric, in one embodiment, comprises of a thin film of silicon nitride which is the same thin film used for the thin-film transistor gate dielectric layer. Each of the first electrodes 291 is coupled to a corresponding photosensor 120 and a corresponding thin film switching transistor 130, respectively. Second electrodes 296 are coupled to a capacitor linear electrode 251. In one embodiment, the second electrode comprises the capacitor linear electrode.

The capacitor linear electrode is coupled to an edge of the capacitor array. The edge refers to the edges of the array. At the edges of the array, all the linear electrodes are coupled together, either by the same metal or with metals used for other layers. In addition, at the edge, the capacitor linear electrode is coupled to the bias electrode for the photodiode 120, thus completing the parallel electrical configuration between the capacitors and the diodes. By effectively coupling the storage capacitors, the bias voltage is applied at the edges of the array, thereby avoiding the need for applying the bias voltage at each pixel. Such an arrangement maximizes the pixel fill factor.

The capacitor array further comprises a plurality of bridges 271 coupled between adjacent capacitor linear electrodes 251 for redundancy. For example, if the linear electrode is cut in several locations during a repair process, resulting in sections that are electrically isolated, the bridges ensure that the linear electrodes remain coupled together. By adding the redundancy, the probability is greatly reduced of having sections that are electrical isolated or are floating.

The capacitor array further comprises a plurality of narrow electrodes under a plurality of intersection points corresponding to the point of intersection between the plurality of data lines and the plurality of scan lines and the point of intersection between the plurality of data lines and the plurality of bridges. In FIG. 3, points 264 and 275 are intersection points.

In the imager 200, each storage capacitor is designed to store more charge than the photodiode that it is coupled to, thereby increasing the charge storage capacity of each pixel while avoiding the problems associated with the use of thinner photodiodes (point defects) or high bias voltages (high leakage currents). In addition, since a significant amount of the charge is stored on the capacitor, a given signal level will cause a smaller bias change across the photodiode leading to lower lag. The higher charge storage capacity maximizes the gain of the photodiode without saturating the pixel, which in turn allows the reduction of the sensitivity to electronic noise. Also, since it is easier to control the deposition uniformity of dielectrics, the pixel capacitance uniformity over a large area-imaging device is improved.

In addition, there are other advantages to this particular design. In particular, the plurality of capacitor linear electrodes is parallel to the plurality of data lines so as to minimize transient currents in the linear electrodes during a data read operation by the imager. Thus, when a scan line is biased, the corresponding pixel and capacitor charges are discharged through the data line and the corresponding linear capacitor electrode, thus reducing the transient current in each linear capacitor electrode. Reducing transient currents improves reliability of electrodes and conductors that couple various layers and improves the imager performance because large currents will produce large transient voltage excursion due to finite line resistance. In addition, the storage capacitor array ensures that any bias lines in the imager are immune to opens and shorts.

In another embodiment, each one of the linear electrodes is disposed under a corresponding one of the plurality of scan lines and are split into two parallel electrodes to increase the probability of successful repair of a short. If either cross-over is shorted, the shorted cross-over can be cut with a laser or other methods. The electrical continuity of the line 251 will not be affected.

The previously described embodiments of the present invention have many advantages, including a design for a low defect capacitor array that minimizes shorts and transient current on the capacitor electrodes, thus enhancing the picture quality of the imager.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An imager, comprising:
a plurality of pixels disposed on a substrate in an imaging array pattern comprising rows and columns, each of said pixels comprising a respective photosensor coupled to a respective thin film switching transistor;
a plurality of scan lines disposed at a first level with respect to said substrate along a first axis of said imaging array pattern, each row of pixels in said imaging array pattern having a respective scan line, each of said respective scan lines being coupled to a respective gate electrode in said thin film switching transistors for each pixel disposed along the respective row of pixels in said imaging array pattern;
a plurality of data lines disposed at a second level with respect to said substrate along a second axis of said imaging array pattern, each column of pixels in said imaging array pattern having a corresponding data line, each of said respective data lines being coupled to a respective readout electrode in said thin film switching transistors for each pixel disposed along the respective column of pixels in said imaging array pattern, and
a storage capacitor array comprising a plurality of capacitors disposed on the substrate, each of the plurality of capacitors comprising a first electrode, a second electrode and a dielectric disposed between the first electrode and the second electrode; the first electrode being coupled to a corresponding photosensor and a corresponding thin film switching transistor, and the second electrode coupled to a capacitor linear electrode.

2. The imager of claim 1, wherein the capacitor linear electrode is coupled to an edge of the capacitor array, wherein a voltage bias is applied to the edge of the array.

3. The imager of claim 1, further comprising a plurality of bridges coupled between adjacent linear capacitor electrodes for redundancy.

4. The imager of claim 1, further comprising a plurality of narrow electrodes under a plurality of intersection points, the plurality of intersections points corresponding to the point of intersection between the plurality of data lines and the plurality of scan lines and the point of intersection between the plurality of data lines and the plurality of bridges.

5. The imager of claim 1, wherein the plurality of linear electrodes are parallel to the plurality of data lines to minimize transient currents during a data read operation by the imaging device.

6. The imager of claim 1, wherein each one of the linear electrodes disposed under a corresponding one of the plurality of scan lines are split into two parallel electrodes for redundancy.

7. The imager of claim 1, wherein the plurality of data lines is electrically insulated from the plurality of scan lines.

8. The imager of claim 1, wherein the second electrode comprises the capacitor linear electrode.

9. The imager of claim 1, wherein the imager is an x-ray imager.
